(19) United States
(12) Patent Application Publication
(10) Pub. No.: US 2005/0127652 A1
(43) Pub. Date: Jun. 16, 2005

(54) Method for folding a gas bag, a device for folding a gas bag and a folded gas bag

(75) Inventor: Robert Krygier, Czestochowa (PL)

Correspondence Address: TAROLLI, SUNDHEIM, COVELL & TUMMINO L.L.P.;1111 LEADER BLDG., 526 SUPERIOR AVENUE, CLEVELAND, OH, 44114-1400, US

(73) Assignee: TRW Automotive Safety Systems GMbH

(21) Appl. No.: 11/011,816

(22) Filed: Dec. 14, 2004

(30) Foreign Application Priority Data
Dec. 15, 2003 (DE) 103 58 564.8
Jun. 9, 2004 (DE) 10 2004 028 048.7

(51) Int. Cl. B60R 21/16

(52) U.S. Cl. 280/743.1

(57) ABSTRACT

The invention relates to a method for folding a gas bag with the following steps: Firstly, the gas bag is spread out flat on a base. Then a ring-shaped outer region of the gas bag, which surrounds a central region, is bent through approximately 90 degrees, so that the outer region surrounds the central region in an apron shape. Then the outer region is pushed together towards the base. The invention also relates to a device for folding a gas bag and also a folded gas bag.

The invention relates to a method for folding a gas bag. The invention also relates to a device for folding a gas bag. Finally, the invention relates to a folded gas bag.

### BACKGROUND OF THE INVENTION

Such a gas bag is part of a vehicle occupant restraint system by which a vehicle occupant is to be protected from injuries. In an emergency, the gas bag must be transferred as quickly as possible from a folded, space-saving state into an unfolded state. Inter alia, the manner in which the gas bag has been folded plays a part here, because both the unfolding speed and also the unfolding direction of a gas bag can be influenced by how the wall has been folded.

In the prior art, a plurality of methods is known in order to fold a gas bag in a space-saving manner. Most methods consist of a plurality of individual, precisely defined folding steps. In addition, methods are known in which the gas bag is substantially pushed together, so that no precisely folded gas bag is obtained, but rather a folded gas bag with a wall running at least partially in a chaotic manner.

The object of the invention consists in providing a method for folding a gas bag which is distinguished by a small effort. The object of the invention further consists in providing a device for folding the gas bag. The object of the invention finally consists in providing a gas bag which folded by simple means.

### BRIEF DESCRIPTION OF THE INVENTION

To solve this problem in accordance with the invention, a method is provided for folding a gas bag, which contains the following steps: Firstly the gas bag is spread out flat on a base. Then a ring-shaped outer region of the gas bag, which surrounds a central regions, is bent through approximately 90 degrees, so that the outer region surrounds the central region in an apron shape. Finally, the outer region is pushed together towards the base. In this way, with little effort, a gas bag is obtained which is folded in a space-saving manner. It is particularly advantageous here that the wall is situated largely in a ring which surrounds the central region of the gas bag. This method is suitable in particular for so-called doughnut gas bags, i.e. for gas bags which consist substantially of a tube-shaped bead.

To solve the above-mentioned problem, a device is also provided for folding a gas bag, which is characterized in that it has a base which has a fixed central section and a moveable folding element, and also a ring-shaped outer stamp, the external diameter of which corresponds approximately to the external diameter of the central section and which can be moved from an initial position into a folding position pressed against the base. This device is distinguished in that the gas bag can be brought with very little effort into a cup-shaped form, from which it can be pushed together with little effort.

The above-mentioned problem is solved, finally, by a folded gas bag which is characterized in that it has a central region, spread out flat, and a ring region surrounding the latter, in which the wall of the gas bag is pushed together in a chaotic manner.

Advantageous developments of the invention will be apparent from the sub-claims.

### BRIEF DESCRIPTION OF THE DRAWINGS

The invention is described below with the aid of preferred embodiments which are illustrated in the enclosed drawings. In these:

FIG. 1 shows a diagrammatic section through a device according to a first embodiment of the invention for folding a gas bag in a state before the start of the process;

FIG. 2 shows diagrammatically a top view along the arrows II of FIG. 1;

FIG. 3 shows a view corresponding to that of FIG. 1, the device being in an intermediate stage of the process;

FIG. 4 shows a view corresponding to that of FIG. 3, the device being in a state after completion of the process;

FIG. 5 shows a diagrammatic section through a device according to a second embodiment of the invention for folding a gas bag in a state at the start of the process;

FIG. 6 shows a diagrammatic section through the device of FIG. 5, after a first process step has been carried out;

FIG. 7 shows a diagrammatic section through the device of FIG. 5, after a second process step has been carried out;

FIG. 8 shows a diagrammatic section through the device of FIG. 5 after the gas bag has been folded in finished form; and

FIG. 9 shows a section along the plane IX-IX of FIG. 8.

### DETAILED DESCRIPTION OF THE INVENTION

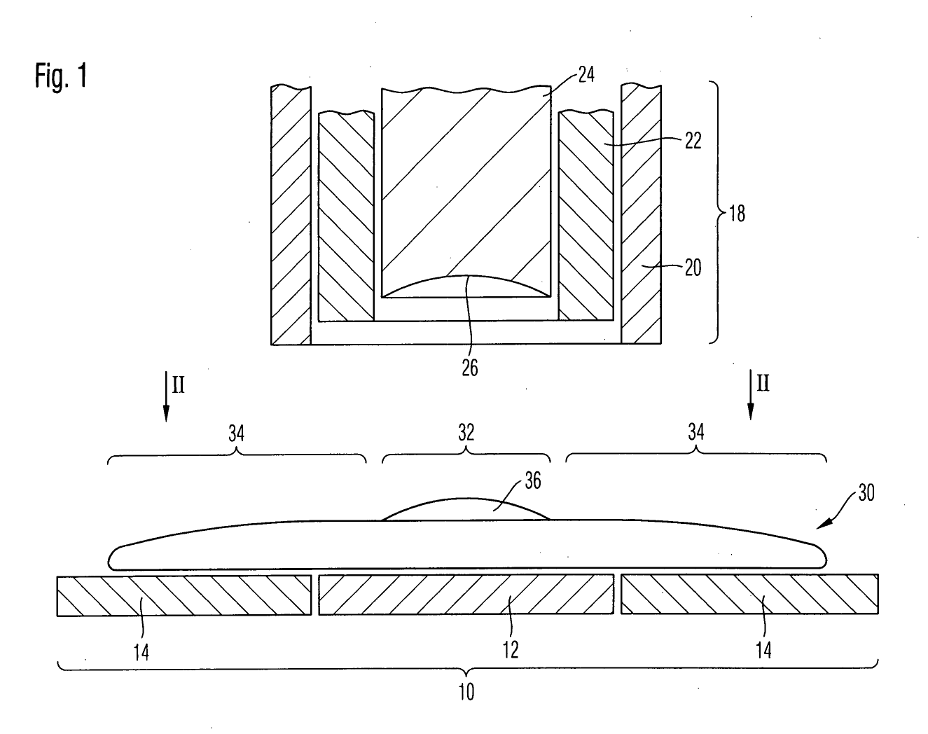

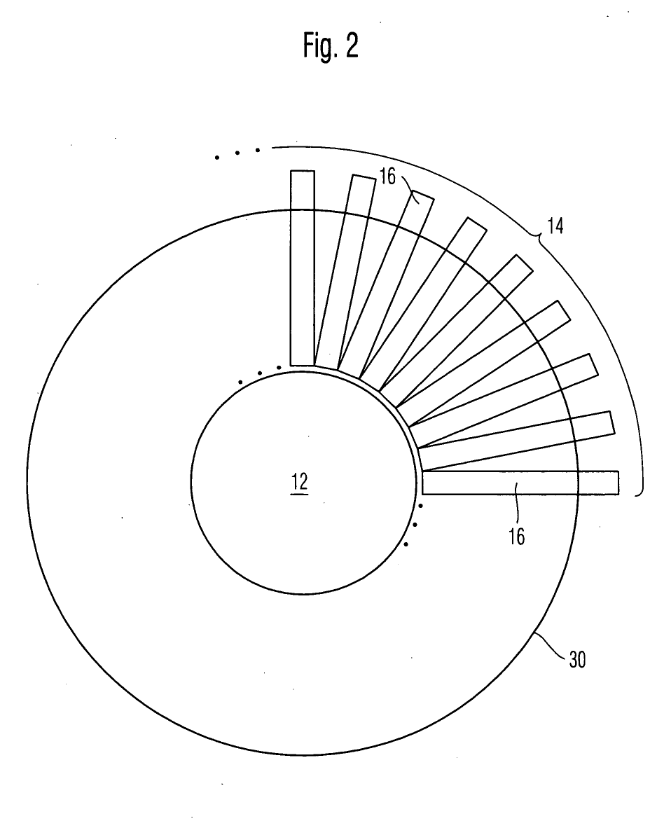

In FIGS. 1 and 2 a first embodiment is shown of a device for folding a gas bag. The device has a base 10 which consists of a fixed central section 12 and a foldable outer section 14, which forms a folding element. The foldable outer section extends in a ring shape around the central section 12 and consists of a plurality of individual segments which are constructed here as fingers 16 having a constant width. The fingers 16 can be folded from an initial position, which is shown in FIGS. 1 and 2 and in which they are situated in the same plane as the central section 12, through approximately 90 degrees upwards with respect to FIG. 1. This is explained in further detail below. To move the fingers 16, any desired mechanism (not illustrated) can be used.

At a distance from the central section 12, a folding unit 18 is arranged, which consists of a guide 20, an outer stamp 22 and a central stamp 24. The guide 20 is fixed relative to the central section 12; in addition, it is arranged concentrically thereto. The ring-shaped outer stamp 22 is movable towards the base, starting from the initial position shown in FIG. 1, in which it is situated at a distance from the central section 12 of the base 10. For this, any desired thrust system can be used. The external diameter of the outer stamp 22 corresponds approximately to the external diameter of the central section 12 of the base 10. Within the ring-shaped outer stamp 22, the central stamp 24 is arranged, which can likewise be moved, starting from the initial position shown into a position displaced forward towards the base 10. For this, also, a suitable thrust mechanism (not illustrated) is provided.

In a first step for folding a gas bag 30, the latter is spread out flat on the base 10. Assuming that the gas bag is circular in the spread out state, it is arranged centrally on the base 10. In a central region 32, the gas bag has an emblem 36 which is later a part of a gas bag module in which the folded gas bag 30 is arranged. The ring-shaped outer region 34 of the gas bag lies on the fingers 16 of the base 10. Owing to the inherent rigidity of the gas bag, it is not harmful that the fingers 16 have an increasing distance from each other with an increasing distance from the center of the base 10; the fingers 16 are arranged so that they only touch each other at their radially inner end.

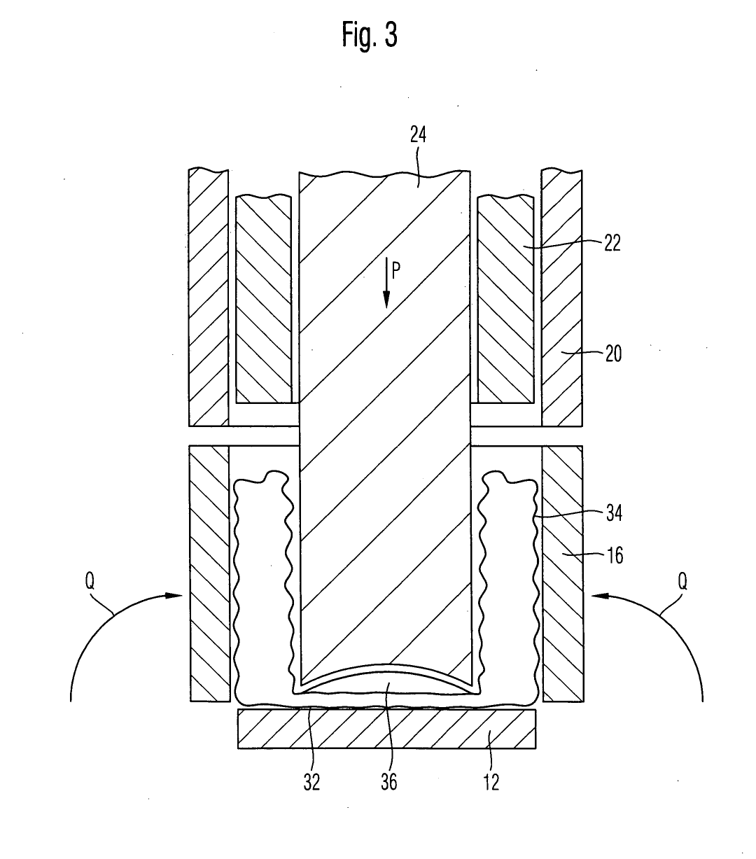

In a second step for folding the gas bag, firstly the central stamp 24 is moved forward in the direction of the arrow P of FIG. 3 so that the central region 32 of the gas bag 30 is clamped against the central section 12 of the base 10. In so doing, the central stamp 24 engages with a recess 26, provided on its front end side, on the emblem 36. The central region 32 of the gas bag is therefore fixed securely. Then the fingers 16 are folded upwards through 90 degrees (see arrows Q in FIG. 3), so that together with the central section 12 of the base 10 they form an almost closed cup. On folding up of the fingers 16, the ring-shaped outer region 34 of the gas bag 30 is likewise folded or bent upwards so that it is arranged in the space between the central stamp 24 and the fingers 16. This state is shown in FIG. 3.

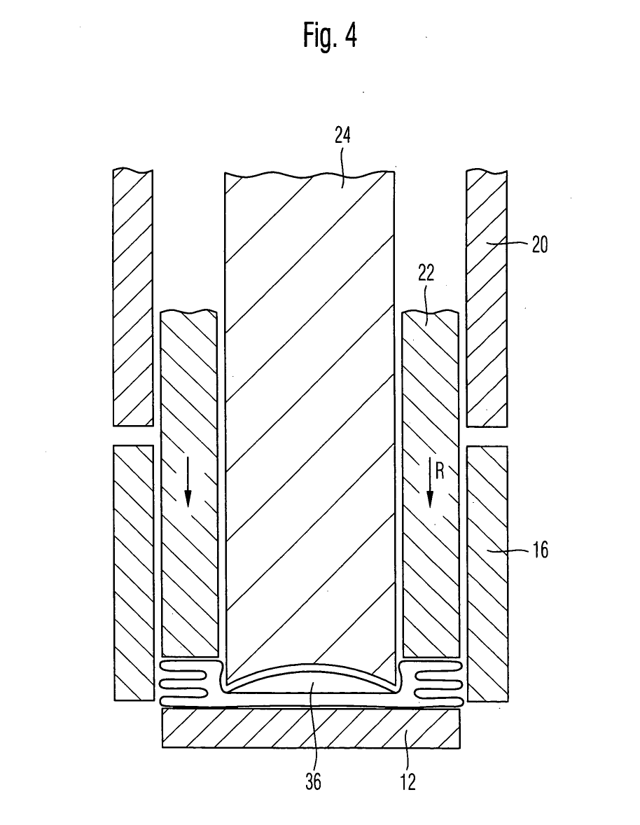

As a next step, the outer stamp 22 is pushed forward from its initial position downwards towards the central section 12 of the base into a folding position (see arrow R in FIG. 4). Here, the outer region 34 of the gas bag is pushed together towards the base 10 in a ring-shaped space between the central stamp 24 and the fingers 16, which form an almost closed, cylindrical wall. In this way, the desired space-saving folded state of the gas bag 30 is obtained.

After the folding of the gas bag, the latter can be further processed in a manner known per se, for example inserted into a gas bag module or enclosed in a casing.

A particular advantage of the method for folding the gas bag consists in that an optimum utilization of the available packing space is achieved, in particular because only with the last stage of folding, carried out by the forward movement of the outer stamp 22, is the desired high tamping of the gas bag package is achieved. The previous steps, on the other hand, can be carried out with little expenditure of force. A particular advantage of the device for folding the gas bag consists in that it is constructed so as to be mechanically simple. In addition, the gas bag is transferred with little effort from its flat, spread-out state into the state shown in FIG. 3, in which it an be pushed together in an annular space. In particular, no complicated grippers are necessary in order to bring the gas bag into the annular space, and the gas bag also does not have to be inflated, so that it would subsequently have to be relieved of air again on folding. The folded gas bag is distinguished in that its wall is reliably folded in an annular space and can not be pushed together in a central region. This is particularly advantageous in doughnut gas bags.

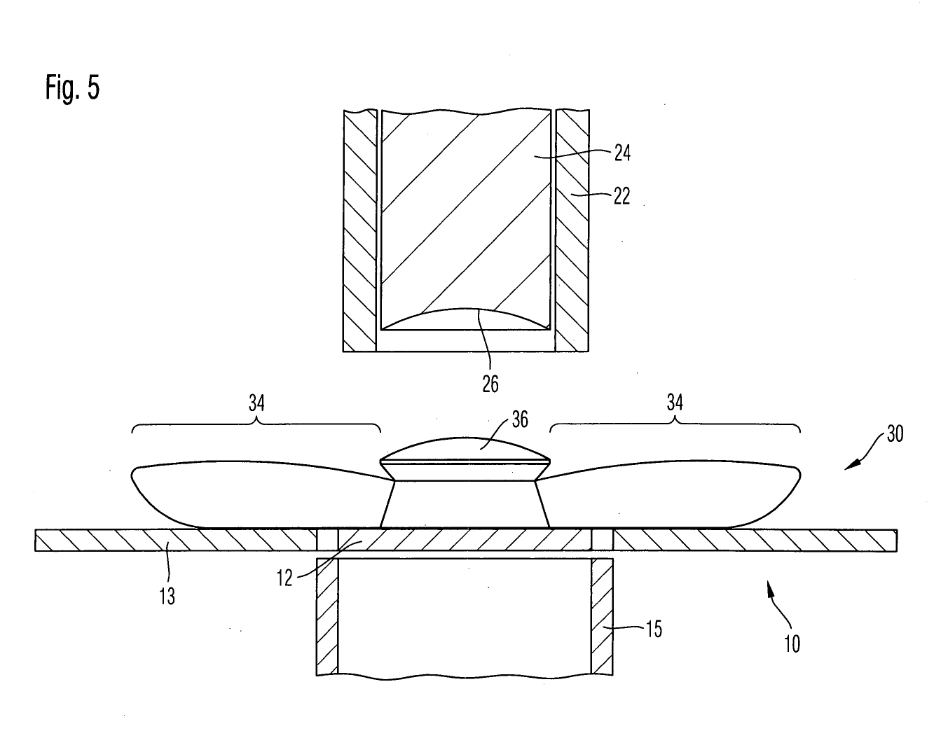

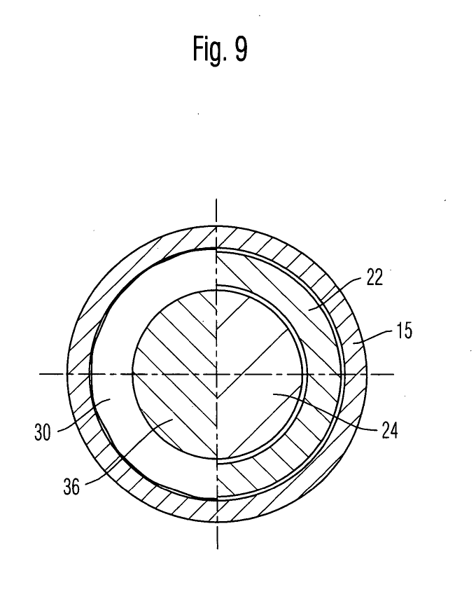

In FIGS. 5 to 9 a second embodiment of a device for folding a gas bag is shown. The same reference numbers are used for the components known from the first embodiment, and in this respect reference is to be made to the above descriptions.

The most essential difference between the first and the second embodiment consists in that in the second embodiment the base 10 is constructed as a whole so as to be fixed; the fixed central section 12 is surrounded by a ring-shaped, likewise fixed, outer section 13. Between the central section 12 and the outer section 13, a gap is situated, under which a folding element 15 is arranged in the form of a turnover sleeve. The turnover sleeve is movable upwards in a translatory manner through the gap, i.e. towards the outer stamp 22.

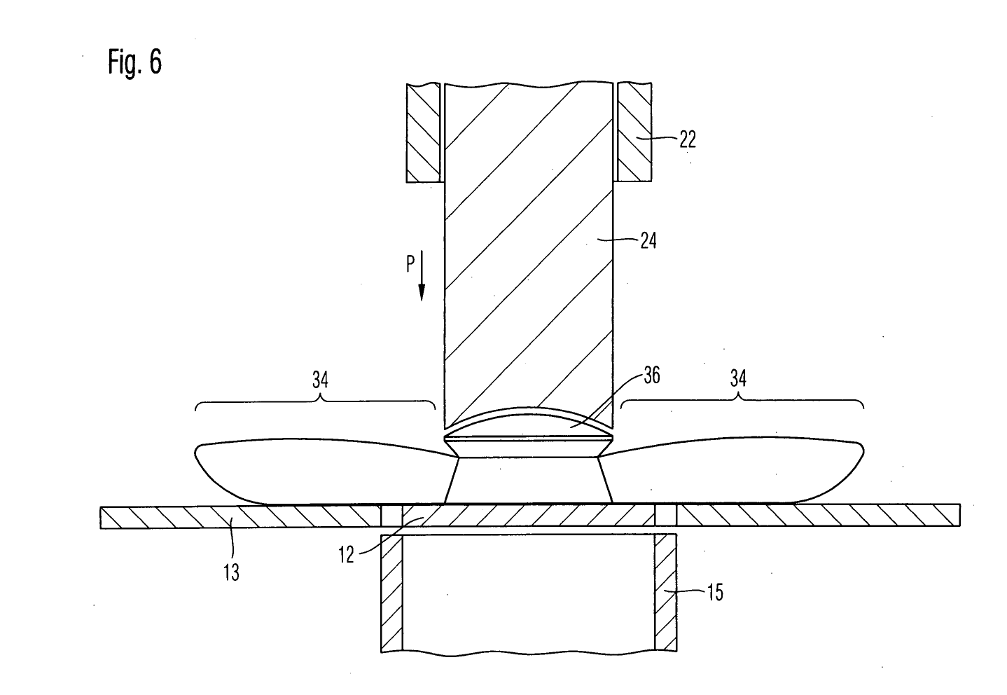

Also in the second embodiment, the gas bag is firstly spread out flat on the base 10. Then the gas bag can be filled slightly with air, so that the side parts 34 bulge slightly (see FIG. 5). This facilitates the further processing. Then the central stamp 24 is moved downward in the direction of the arrow P (see FIG. 6), so that it engages with its recess 26 on the emblem 36 and thereby fixes the gas bag on the base 10.

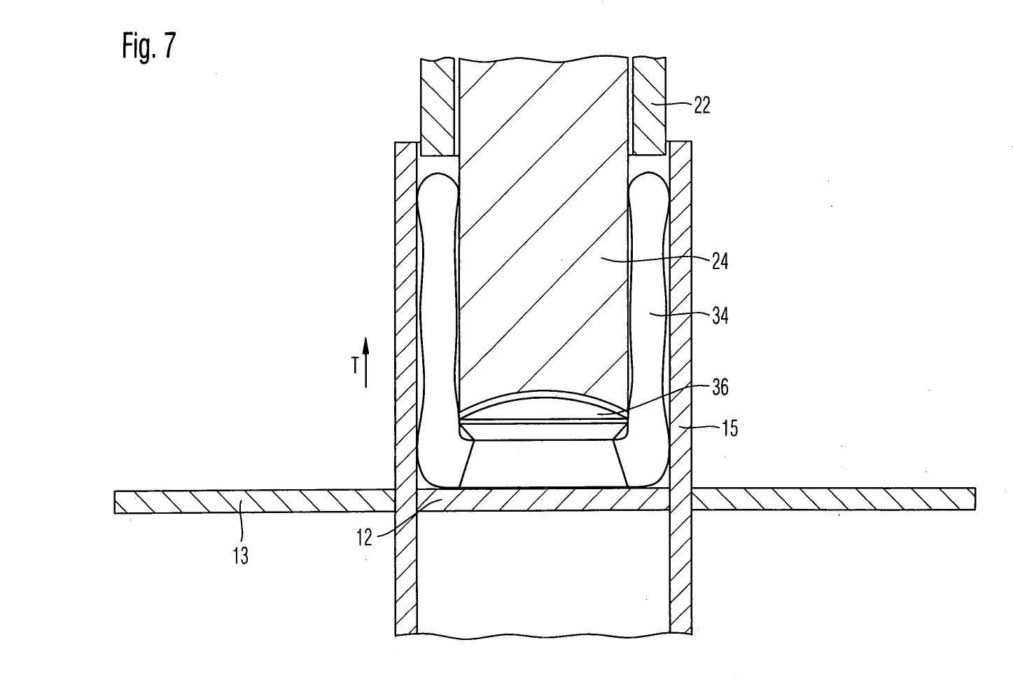

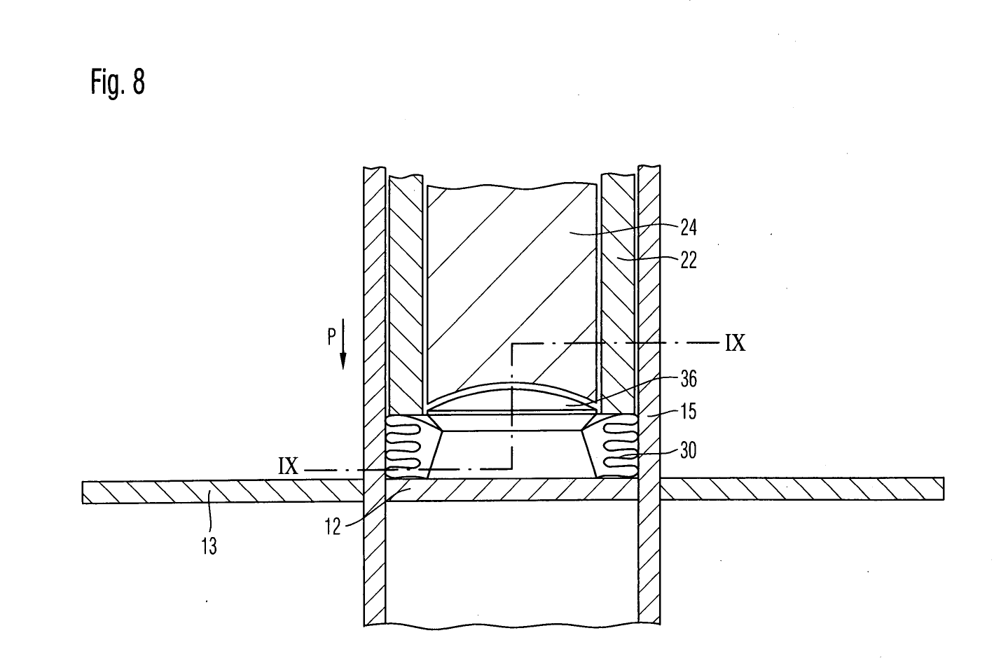

Then the turnover sleeve 15 is moved upwards in the direction of the arrow T (see FIG. 7), so that the gas bag is drawn upwards and is brought into an apron-shaped form around the central stamp 24. The turnover sleeve 15 is moved so far until it overlaps with the outer stamp 22. Finally, the outer stamp 22 can be moved towards the base 10 again in the direction of the arrow P (see FIG. 8), so that the gas bag 30 is pushed together in the annular space between the inner stamp 24 and the turnover sleeve 15. In so doing, the air contained in the gas bag escapes out of the inflation opening.

The second embodiment is distinguished by a small structural effort; all the moving parts can be moved simply in a translatory manner, for example by hydraulic cylinders.

1. A method for folding a gas bag by means of the following steps:
said gas bag is spread out flat on a base,
a ring-shaped outer region of said gas bag, which surrounds a central region, is bent through approximately 90 degrees, so that said outer region surrounds said central region in an apron shape;
said outer region is pushed together towards said base.

2. The method according to claim 1, characterized in that said outer region is drawn in or turned in.

3. The method according to claim 1, characterized in that said outer region is folded over.

4. The method according to claim 1, characterized in that said central region of said gas bag is fixed before said outer region is bent.

5. A device for folding a gas bag, characterized in that it has a base which has a fixed central section and a movable folding element, and also a ring-shaped outer stamp, an external diameter of which corresponding approximately to an external diameter of said central section and which can be moved from an initial position into a folding position pressed against said base.

6. The device according to claim 5, characterized in that said folding element forms an outer section of said base and consists of a plurality of foldable individual segments.

7. The device according to claim 6, characterized in that said foldable individual segments, when they are brought from an initial position in which they are situated in a plane which is the same as of said central section into a swung-out position, form a cup together with said central section.

8. The device according to claim 7, characterized in that said foldable individual segments are fingers having a constant width.

9. The device according to claim 5, characterized in that said folding element consists of a turnover sleeve which is displaceable in a translatory manner.

10. The device according to claim 5, characterized in that a central stamp is provided which is arranged within said outer stamp (22) and can be moved from an initial position into a folding position pressed against said base.

11. A folded gas bag, characterized in that it has a flat spread-out central region and a ring region surrounding the latter, in which a wall of said gas bag is pushed together in a chaotic manner.

12. The gas bag according to claim 11, characterized in that said gas bag is provided with an emblem which is arranged on an unfolded central region.
